(19) United States
(12) Patent Application Publication
(10) Pub. No.: US 2016/0286360 A1
(43) Pub. Date: Sep. 29, 2016

(54) LOCATION SERVICE(S) MANAGEMENT FOR MOBILE DEVICE(S)

(71) Applicant: YANDEX EUROPE AG, Luzern (CH)

(72) Inventors: Ron Miller, Herzlia (IL); Yoav CAFRI, Herzlia (IL); Omri MORAN, Tel-Aviv (IL)

(21) Appl. No.: 15/035,611

(22) PCT Filed: Nov. 11, 2014
(86) PCT No.: PCT/IB2014/065964

§ 371 Date: May 10, 2016

Related U.S. Application Data
(60) Provisional application No. 62/071,951, filed on Nov. 11, 2013.

(51) Int. Cl. H04W 4/02; G01C 21/36; H04L 29/08

(52) U.S. Cl. CPC H04W 4/028; H04L 67/306; G01C 21/3682

(57) ABSTRACT

A method of operating one or more location services of a mobile device. The method comprises accessing a dataset which geographically maps a plurality of points of interest (POIs), estimating a movement route of a user of a mobile device to a user desired destination, selecting at least one of the plurality of POIs based on a proximity to the estimated movement route, calculating an estimated time of arrival of the user to a proximity with the at least one selected POI, and timing a switch in an operation mode of the at least one location service from an idle mode to an active mode according to the estimated time of arrival.

### CROSS-REFERENCE TO RELATED APPLICATIONS

The present application claims priority to the United States Provisional Patent Application (serial number not yet assigned) resulting from the conversion of U.S. patent application Ser. No. 14/076,327, filed Nov. 11, 2013, entitled “Location Service(s) Management for Mobile Device(s)”. That application is incorporated by reference herein in its entirety for all purposes.

### BACKGROUND

The present invention, in some embodiments thereof, relates to resource management and, more specifically, but not exclusively, to methods and systems of location service(s) management for mobile device(s).

Location based services (LBS) are typically used by mobile device users in order to access and receive information via the user's mobile device based on the geographical location of the mobile device. Currently, LBSs offer a vast range of services for the mobile device user based on the mobile devices geographical location. The number of possible uses of LBSs is vast and covers many topics from information services to entertainment services including gaming.

Usually, the geographical location of a mobile device is determined by identifying a cellular network cell that the mobile device is in communication with, detecting, using the mobile device, one or more wireless network(s) having known location(s), and/or acquiring coordinates using a global positioning system (GPS) module of the mobile device and/or a device paired and/or otherwise connected thereto.

### SUMMARY

According to an aspect of some embodiments of the present invention there is provided a method of operating one or more location services of a mobile device. The method comprises accessing a dataset which geographically maps a plurality of points of interest (POIs), estimating a movement route of a user of a mobile device to a user desired destination, selecting at least one of the plurality of POIs based on a proximity to the estimated movement route, calculating an estimated time of arrival of the user to a proximity with the at least one selected POI, and timing a switch in an operation mode of the at least one location service from an idle mode to an active mode according to the estimated time of arrival.

Optionally, the method comprises: monitoring a plurality of movement events of the user during a period of at least one day; and calculating at least one routine movement pattern of the user according to the monitored movement events. The at least one of the movement route and the user desired destination is estimated according to the at least one routine movement pattern.

Optionally, at least one of the movement route and the user desired destination is estimated according to a destination set by the user in a navigation service provided on the mobile device.

Optionally, at least one of the movement route and the user desired destination is estimated according to a destination set by the user in a navigation service provided on the mobile device.

Optionally, at least one of the movement route and the user desired destination is estimated according to a semantic analysis of user data stored on the mobile device.

Optionally, at least one of the movement route and the user desired destination is estimated according to data acquired using a motion sensor of the mobile device.

Optionally, the user data comprises at least one of a plurality of calendar events and a plurality of electronic messages.

Optionally, at least one of the movement route and the user desired destination is estimated according to an analysis of a log of callees and call recipients of calls made using the mobile device.

Optionally, the plurality of POIs are defined and used by an application hosted on the mobile device and uses the at least one location service; further comprising using data acquired using the at least one location service to trigger an application event by the application.

More optionally, the plurality of POIs comprises a first group of POIs originated from one application hosted on the mobile device and a second group of POIs originated from another application hosted on the mobile device; wherein POIs of the first group are used to trigger an application event of the another application.

Optionally, the application event is checking if the mobile device is in one of the plurality of POIs.

Optionally, the method comprises identifying a plurality of applications hosted in the mobile device; wherein the at least one selected POI is defined and used by at least one of the plurality of applications.

More optionally, the method further comprises automatically updating the plurality of POIs according to an input from at least one of the plurality of applications.

Optionally, the selecting is performed according to a current time.

Optionally, the timing comprises defining a frequency of repeating the switch intermediately according to the estimated time of arrival.

Optionally, the method comprises: downloading a subgroup of the plurality of POIs based on statistical data indicative of movement of the user and locally performing the selecting from the subgroup on the mobile device.

According to an aspect of some embodiments of the present invention there is provided a mobile device which operates one or more location services. The mobile device comprises a processor, a movement sensor which detects movement of the mobile device, at least one location service module which detects a location of the mobile device, a database storing a dataset which geographically maps a plurality of points of interest (POIs), a client module which estimates, using the processor, a movement route of a user of a mobile device to a user desired destination according to data from at least one of the movement sensor and the at least one location service module, selects one of the plurality of POIs as a selected POI for the user based on the current movement, and calculates an estimated time of arrival of the user to a proximity with the selected POI, and an interface module which instructs the operation of the at least one location service according to the estimated time of arrival.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method for operating one or more location services of a mobile device based on an expected proximity to one or more points of interest (POIs) from a dataset of POIs, according to some embodiments of the present invention;

FIG. 2 is a schematic illustration of a POI defined by a presence identification area set according to a bounding radius and bounds a push area set according to an event activation radius, according to some embodiments of the present invention; and

FIG. 3 is a schematic illustration of a system of managing the operation of one or more location services of a mobile device, according to some embodiments of the present invention.

### DETAILED DESCRIPTION

The present invention, in some embodiments thereof, relates to resource management and, more specifically, but not exclusively, to methods and systems of location service(s) management for mobile device(s).

According to some embodiments of the present invention, there are provided methods and systems of reducing resource consumption at a mobile device by managing the operation of location service module(s), such as a GPS module, based on an estimated movement route and a geographical location of points of interest associated with applications executed on the mobile device.

Optionally, the movement route is estimated based on an analysis of a dynamic-statistic user profile that is generated by monitoring user(s) movements and/or activities. The dynamic-statistic user profile allows estimating future user destination and route taken for arriving at these destinations.

Optionally, the movement route is estimated based on data acquired from motion sensors of the mobile device. For example, an accelerometer, a gyroscopic module, a compass, and/or an image sensor.

Optionally, the movement route is estimated based on data acquired from a navigation service running on the mobile device.

Optionally, the movement route is estimated based on data acquired semantic analysis of user related data, such as recently received and/or sent textual messages and/or calendar objects related to upcoming and/or currently held events.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

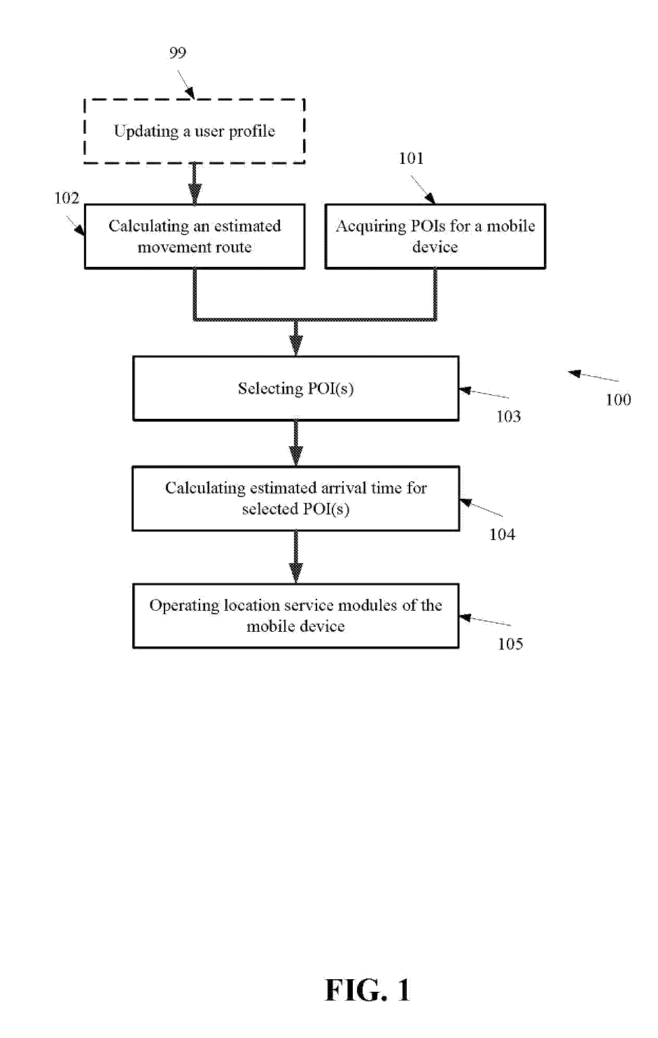

Reference is now made to FIG. 1, which is a flowchart of a method 100 for operating one or more location services of a mobile device based on an expected proximity to one or more points of interest (POIs) from a dataset of POIs, according to some embodiments of the present invention. The method allows reducing resource usage, such as power, network access, memory and computational power consumption. For example, the method allows reducing battery consumption by maintaining location service modules in an idle mode as long as the mobile device is not expected to be in proximity to one or more POIs. As used herein, a POI means a location defined such that when a mobile device user, for example a subscriber and/or a user of a mobile device application, is nearby application event(s) should be triggered. For example, a POI may be an action POI set by an application to trigger an action to which a user reacts and a next place POI set as an outcome of a prediction of the next place the user is going to be at, for instance as a check point. Examples for application event(s) includes notification presentation event(s) wherein notice(s), such as promotional data, are rendered on the screen of the mobile device, registration event(s) during which the presence of the mobile device user in a certain area is registered, logging event(s) wherein data indicative of the presence of the user in proximity to a certain area is logged, and/or monitoring event(s) wherein data indicative of movement of the user is monitored and/or logged. Examples for application event(s) may be push notification at a POI and/or an event logging indicating a presence at a reference point.

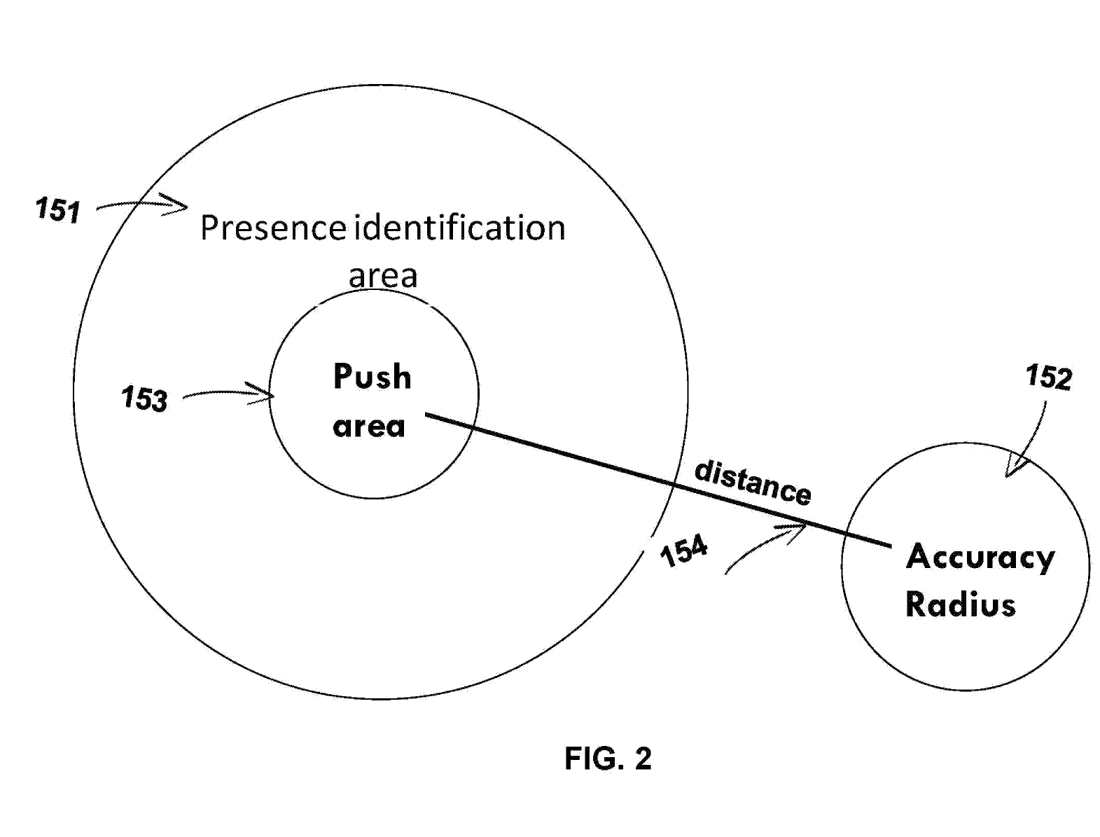

Optionally, each POI has a geo-fence, a virtual perimeter defined to bound one or more real-world geographic areas. For example, POI may be a shopping center and a geo-fence around the shopping center boundaries. The geo-fence may be dynamically or manually generated as in a radius around an area of interest, such as a store. Optionally, as shown at FIG. 2, a POI is defined by a presence identification area 151 set according to a bounding radius and bounds a push area 153 set according to an event activation radius. As described below, the location service module(s) are operated to be at an idle mode when the mobile device is not in proximity to POI and in an operative mode when the mobile device is in proximity to the POI. In such a manner, the presence of the user at the event activation radius can be detected by the location service module(s).

The method may be used for activating location based service application(s) installed in a mobile device at the time of need and/or for deactivating location based service application(s) installed in the mobile device when acquired location information is up-to-date.

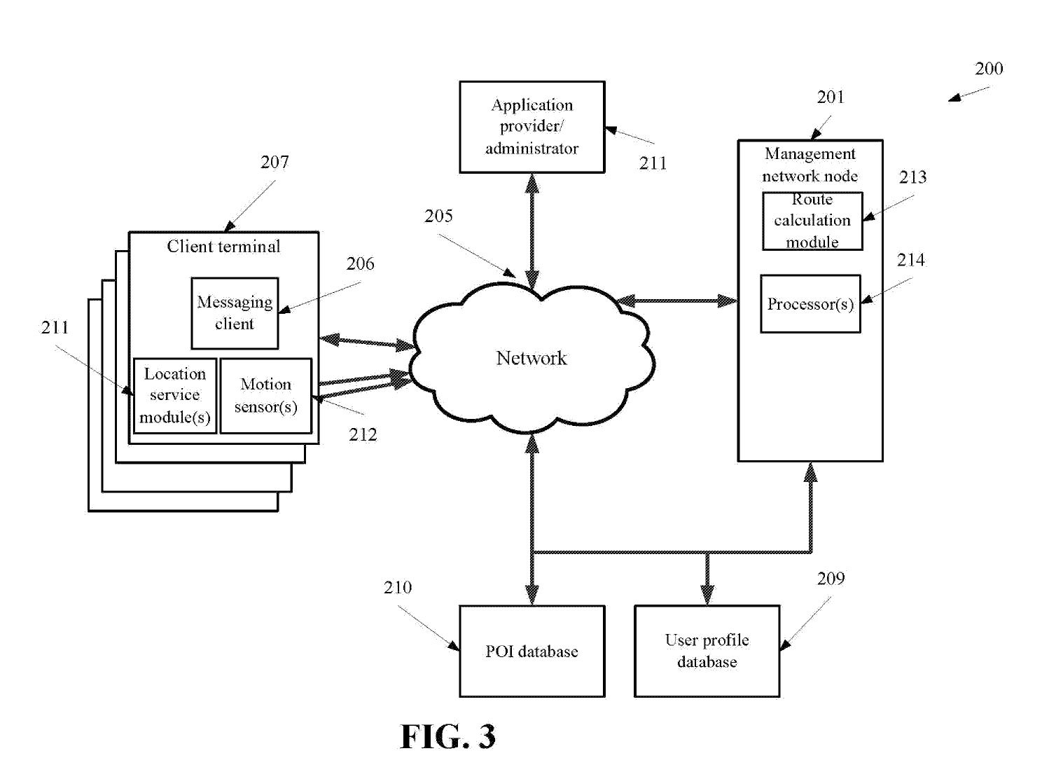

Reference is also made to FIG. 3, which is a schematic illustration of a system 200 of managing the operation of one or more location services of a mobile device, according to some embodiments of the present invention, for instance for implementing the method recited in FIG. 1. The system 200 comprises a management network node 201, for example one or more servers 202, which are connected, via a communication network 205, such as the Internet, to a plurality of client modules 206 each installed in mobile device 207, such as a Smartphone, a tablet, and/or a wearable device, such as Google GLASS™. The management network node 201, for brevity referred to herein as a management server 201, is connected to a POI database 210, either directly or via the network 205, which stores a dataset which geographically maps a plurality of POIs. Additionally or alternatively, a copy of the dataset and/or portions thereof is stored in the memory of the mobile devices 207, facilitating local access thereto and/or peer to peer access according to storage sharing methodologies.

The POI may be a retailer area, such as a store, a gas station, and/or the like, and/or any other region of interest for providing content, such as informative and/or promotional content. Optionally, the dataset of POIs comprises a plurality of sub datasets, each geographically maps POIs related to a certain application, for example a certain application of a chain of stored wherein is store is represented by a different POI, a gas station related application wherein each gas station is represented by a different POI, and a fashion label application wherein each point of sale is represented by a different POI.

The POI database 210 may be updated by a network node that is managed by application operator(s) 211, such as application providers and/or managers, for example via a designated client(s) and/or by users of the mobile devices 207.

The method described in FIG. 1 is described as performed by one of the mobile devices 207. This method may be performed separately by all of the mobile devices 207, for example at the same time or interchangeably. Some calculations may be performed by the management server.

First, as shown at 101, the local and/or central POI database 210 is accessed by the client module 206 to acquire some of all of the POIs from the dataset stored in the POI database 210, either directly or via the managing server 201. For example, a subgroup of POIs may be downloaded to the client terminal 207 so as to reduce accesses to the POI database 210 and network usage. The subgroup of POIs is selected based on statistical data to assure that all the POIs needed for this process are locally stored. The subgroup of POIs is optionally downloaded every period, for example every 4 hours based on statistical analysis. The size of the subgroup allows preventing excessive cache use and improves the robustness of the operation of the client module 206. The subgroup of POIs is optionally selected according to movement history and movement data of the user of the client terminal 207, estimating where the user will be in upcoming period, for example in the next 0.5, 1, 2, 4, 6, 8, and/or 10 hours or any intermediate or longer period.

Optionally, the client module 206 acquires and/or locally documents POIs of one or more applications which are installed in the respective mobile client 205 and/or POIs which have been marked as related to the user of the respective mobile client 205. Optionally, the client module 206 acquires only POIs which are related to an estimated movement route of the user of the mobile device, for example an estimated movement route as calculated below. Optionally, POIs of one application is shared with other applications which are documented in the system, for instance based on a match. In such embodiments, POI a restaurant related application can be shared with a delivery related application. This allows one application to use POIs of other applications to improve its exposure and positive interaction with the user.

In use, as shown at 102, a movement route of a user of the mobile device 207 to a desired destination is estimated based on data from movement sensor(s) 212 of the mobile device 207 and/or one or more location service modules 211 of the mobile device and/or a dynamic-statistic profile of the user, for example a dynamic-statistic profile as described below. The movement route may be calculated by the client module 206 or provided by a respective calculation module 213 installed in the management server 201 and executed using its processor(s) 214. As used herein, a motion sensor may be an accelerometer, a gyroscopic module, a compass, and/or an image sensor which captures a sequence of images processed to detect at least motion. As used herein, a location service module may be a GPS module, a cellular module which receives locational data from a cellular network and/or a wireless network based location module which forwards data about wireless networks which are in the detection range of the mobile device 207 to a remote service, for instance data about access points (APs) of wireless local area networks (WLANs).

Optionally, the calculation of the movement route is triggered by a movement detected using the motion sensor(s) and/or location service module(s). Optionally, the calculation of the movement route is based on user destination entered to a navigation service hosted on the device, such as WAZE™ and/or Google Maps™ and/or user destination estimated by the navigation service.

According to some embodiments of the present invention, the calculation of the movement route is based on data from a dynamic and statistic user profile generated, as shown at 99, by monitoring movement events (e.g. staying in one place for a certain time, movement from one place to another, the time it takes to move from one place to another, and/or the road taken when moving from one place to another) and calculating routine movement patterns of the user during a period of days, weeks, months, and/or years, for example at least a day and at least a week. A routine movement pattern may be any positional change of the user that is repeated during a monitoring period of more than a day, for example a repetitive daily or weekly occurrence of a drive and/or a walk from a point A to a point B, a presence in point B for a certain time, and a drive and/or a walk from point B to point A. The user profile may be locally stored in the mobile client 207 and/or in a user profile database 209. The records of the dynamic and statistic user profile are indicative of the user's home address and the time he or she routinely arrives at home and routinely leaves home, the user's work place address and the time he or she routinely arrives at work and routinely leaves work, the user's frequently visited venue addresses, for example the gym, the mall, and the supermarket, and the time he or she routinely arrives at each frequently visited venue and routinely leaves it. The records of the dynamic and statistic user profile are indicative of the time it takes the user to move from one place to another, optionally in different days of the week and/or time of the year.

In such embodiments, some or all of the movements of a user are recorded and analyzed to identify repetitive movement patterns, such as daily, weekly, and/or monthly movement route, for instance from home to work, in work during working days and hours, entrustment and/or family union locations during weekends, communicably visited retailer places, such as stores and/or the like. For example, a dynamic user profile may include a plurality of week day records; each week day record includes a plurality of one hour records. Each one hour record associates a day hour with a movement entry indicative of a common user movement pattern, such as an expected location, an expected drive path, a walk path, and/or an expected arrival to an expected location. Optionally, a coefficient of variation (CV) is calculated per movement entry, for example based on a normalized measure of dispersion, a probability distribution, and/or a frequency distribution of monitored historical movement events. It should be noted that records may represent any time unit.

In such embodiments, a matching movement entry is automatically analyzed and optionally matched with current movement data to estimate a current movement route.

According to some embodiments of the present invention, the calculation of the movement route is based on data from an analysis of visited web pages and/or search queries and/or search results and/or landing pages submitted and/or accessed during the last few minutes, hours, and/or days. In such embodiments, a semantic analysis of the search queries and/or content of the web pages and/or search results and/or landing pages may be indicative of the desired destination of the user. For example, an intention to visit a certain venue such as the gym and/or theater can be extracted from the analyzed content.

Optionally, the calculation of the movement route is based on data from an analysis of addresses in the user's calendar, for example an address of a meeting held during the next few hours. Optionally, the calculation of the movement route is based on data from an analysis of addresses callees and/or callers of calls made during a certain period. The addresses may be extracted from the telephone user interface of the mobile device. Optionally, the calculation of the movement route is based on data from an analysis of addresses of electronic messages sent during a certain period (e.g. emails, instant messaging, and SMS messages) recipients and/or senders. The addresses may be extracted from the contact list of the mobile device.

Now, as shown at 103, one or more of the POIs are selected as selected POI(s) for the user based on the current movement route. The POIs may be calculated by the client module 206 and/or provided by a respective calculation module that is installed in the management server 201. For example, it is calculated which POI(s) are located along and/or in proximity to the movement route of the user and/or in and/or in proximity to the movement route destination and/or along and/or in proximity to alternative movement routes to the user desired destination. For brevity, in proximity to is defined as being in an area that surrounds the POI and/or in the POI and/or borders with the POI and/or an area from which the POI is accessible in a limited time frame, for example few and/or several minutes by foot or by drive.

The selected POI(s) are optionally filtered and/or selected according to relevancy to the applications installed in the mobile device 207. For example, only POIs which are associated with applications hosted and/or running on the mobile device 207 are selected from. In another example, only POIs which are relevant to the time of the day, week, and month are selected from.

As shown at 104, an estimated time arrival (ETA) of the user to proximity with each of the selected POI is calculated based on the movement route and/or alternative movement route calculated for arriving to the user desired destination. The ETA may be calculated by the client module 206 or provided by a respective calculation module that is installed in the management server 201. Optionally, the ETA is calculated based on statistical analysis of the user's walking pace and/or driving habits. Optionally, the ETA is calculated based on data from a navigation service such as WAZE™ and/or Google Maps™ such that current traffic is taken into account.

Optionally, the calculated ETA includes an accuracy radius that is set around the user, taking into account accuracy deviation induced from parameters of the data used for calculating the movement route, for instance the size of data used for calculating the user profile, the accuracy of the movement sensors, the accuracy of the location service modules and/or the like.

As shown at 105, the above allows instructing the mobile device to operate one or more of the location service modules 211 thereof according to the estimated time of arrival(s). For example, the switch in the operation modes of the location service modules 211 is timed according to the estimated time of arrival(s). A switch may be for example from an idle mode to an active mode and vice versa. An idle mode may be any state of the location service module wherein no locational data is gathered and/or calculated, for example when the location service module is not in used. An active mode may be any state of the location service module wherein locational data is gathered and/or calculated, for example when the location service module receives GPS signals, communicates with a cellular network server, searches for WLANS, and/or calculates a current location based on GPS signals, data from the cellular network server, and/or WLANS presence data.

In such embodiments, the location service modules may be triggered at or just before the estimated time of arrival, for example 5 seconds, 5 minutes, 15 minutes and/or intermediate and/or longer periods before each one of the estimated time of arrival(s). Optionally, as shown at 106, a location check is made to indicate that the user is indeed located in proximity to the POI. When the location check fails, new POIs may be selected and a new route may be calculated. When the location check succeeds, the process continues. Additionally or alternatively, the frequency of location identification sessions, namely the frequency in which a location service module is instructed to move from an idle mode to an active mode and to acquire locational data is a derivative of an estimated distance to the POI. For example, when the estimated distance is 100 kilometers, the frequency is once every 40 minutes, when the estimated distance is 10 kilometers, the frequency is once every 5 minutes and, when the estimated distance is 1 kilometer, the frequency is once every 0.5 a minute.

Optionally, of the mobile device 207 is moving towards the POI however did not reach the POI at the ETA, the location service modules are instructed to change to an operative mode from an idle or closed mode for a location check intermediately until the mobile device 207 is in the proximity to or in the POI.

Optionally, when the mobile device 207 is identified in a POI the location service modules are instructed to switch to an idle mode for a time determined, for example, according to the user profile. Optionally, the location service modules are operated according to readings of the motion sensor 212 iteratively check a location change.

The methods as described above are used in the fabrication of integrated circuit chips.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant methods and systems will be developed and the scope of the term a unit, a processor, and a network is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A method of operating one or more location services of a mobile device, comprising:
accessing a dataset which geographically maps a plurality of points of interest (POIs);
estimating a movement route of a user of a mobile device to a user desired destination;
selecting at least one of said plurality of POIs based on a proximity to said estimated movement route;
calculating an estimated time of arrival of said user to a proximity with said at least one selected POI; and
timing a switch in an operation mode of said at least one location service from an idle mode to an active mode according to said estimated time of arrival.

2. The method of claim 1, further comprising:
monitoring a plurality of movement events of said user during a period of at least one day; and
calculating at least one routine movement pattern of said user according to said monitored movement events;
wherein at least one of said movement route and said user desired destination is estimated according to said at least one routine movement pattern.

3. The method of claim 1, wherein at least one of said movement route and said user desired destination is estimated according to a destination set by said user in a navigation service provided on said mobile device.

4. The method of claim 1, wherein at least one of said movement route and said user desired destination is estimated according to a destination set by said user in a navigation service provided on said mobile device.

5. The method of claim 1, wherein at least one of said movement route and said user desired destination is estimated according to a semantic analysis of user data stored on said mobile device.

6. The method of claim 1, wherein at least one of said movement route and said user desired destination is estimated according to data acquired using a motion sensor of said mobile device.

7. The method of claim 1, wherein said user data comprises at least one of a plurality of calendar events and a plurality of electronic messages.

8. The method of claim 1, wherein at least one of said movement route and said user desired destination is estimated according to an analysis of a log of callees and call recipients of calls made using said mobile device.

9. The method of claim 1, wherein said plurality of POIs are defined and used by an application hosted on said mobile device and uses said at least one location service; further comprising using data acquired using said at least one location service to trigger an application event by said application.

10. The method of claim 9, wherein said plurality of POIs comprises a first group of POIs originated from one application hosted on said mobile device and a second group of POIs originated from another application hosted on said mobile device; wherein POIs of said first group are used to trigger an application event of said another application.

11. The method of claim 10, wherein said application event is checking if said mobile device is in one of said plurality of POIs.

12. The method of claim 1, further comprising identifying a plurality of applications hosted in said mobile device; wherein said at least one selected POI is defined and used by at least one of said plurality of applications.

13. The method of claim 12, further comprising automatically updating said plurality of POIs according to an input from at least one of said plurality of applications.

14. The method of claim 1, wherein said selecting is performed according to a current time.

15. The method of claim 1, wherein said timing comprises defining a frequency of repeating said switch intermediately according to said estimated time of arrival.

16. The method of claim 1, further comprising: downloading a subgroup of said plurality of POIs based on statistical data indicative of movement of said user and locally performing said selecting from said subgroup on said mobile device.

17. A mobile device which operates one or more location services, comprising:
a processor;
a movement sensor which detects movement of the mobile device;
at least one location service module which detects a location of the mobile device;
a database storing a dataset which geographically maps a plurality of points of interest (POIs);
a client module which estimates, using said processor, a movement route of a user of a mobile device to a user desired destination according to data from at least one of said movement sensor and said at least one location service module, selects one of said plurality of POIs as a selected POI for said user based on said current movement, and calculates an estimated time of arrival of said user to a proximity with said selected POI; and
an interface module which instructs the operation of said at least one location service according to said estimated time of arrival.

18. A computer program product for operating one or more location services of a mobile device, comprising:
a computer readable storage medium;
first program instructions to access a dataset which geographically maps a plurality of points of interest (POIs);
second program instructions to estimate a movement route of a user of a mobile device to a user desired destination;
third program instructions to select at least one of said plurality of POIs based on a proximity to said estimated movement route;
fourth program instructions to calculate an estimated time of arrival of said user to a proximity with said at least one selected POI; and
fifth program instructions to time a switch in an operation mode of said at least one location service from an idle mode to an active mode according to said estimated time of arrival;
wherein said first, second, third, fourth and fifth program instructions are stored on said computer readable storage medium.
